(19) United States
(12) Patent Application Publication
(10) Pub. No.: US 2026/0106128 A1
(43) Pub. Date: Apr. 16, 2026

(54) ELECTRODE OF SECONDARY BATTERY AND APPARATUS FOR MANUFACTURING ELECTRODE OF SECONDARY BATTERY

(71) Applicant: Samsung SDI Co., Ltd., Yongin-si (KR)

(72) Inventors: SUNGJUN SON, Yongin-si (KR); Sangduck YOO, Yongin-si (KR); Daseul KIM, Yongin-si (KR); Youngha JOO, Yongin-si (KR)

(21) Appl. No.: 19/273,330

(22) Filed: Jul. 18, 2025

(30) Foreign Application Priority Data
Oct. 16, 2024 (KR) 10-2024-0141330

(51) Int. Cl. H01M 4/04; B05C 5/02; B05C 11/10; B05C 11/11; H01M 4/131; H01M 4/133; H01M 4/66

(52) U.S. Cl. CPC H01M 4/0404; B05C 5/0254; B05C 11/1002; B05C 11/11; H01M 4/131; H01M 4/133; H01M 4/661

(57) ABSTRACT

A secondary battery electrode includes a current collector, mixture parts on the current collector, the mixtures parts including a slurry, and the mixture parts being spaced apart and parallel with each other, and uncoated parts on the current collector, the uncoated parts including no slurry, the uncoated parts including an edge uncoated part on an edge of the current collector and a gap uncoated part between the mixture parts, and a width of the edge uncoated part and a width of the gap uncoated part being smaller than a width of each of the mixture parts.

### CROSS-REFERENCE TO RELATED APPLICATION

This application claims priority under 35 U.S.C § 119 to Korean Patent Application No. 10-2024-0141330, filed in the Korean Intellectual Property Office on Oct. 16, 2024, the entire contents of which are hereby incorporated by reference.

### BACKGROUND

### 1. Field

Aspects of embodiments of the present disclosure relate to an electrode of a secondary battery and an apparatus for manufacturing the electrode of a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The positive electrode may be manufactured by applying a slurry for a positive electrode active material onto a current collector, and the negative electrode may be manufactured by applying a slurry for a negative electrode active material onto a current collector. An uncoated portion in which the slurry for the active material is uncoated may be formed in the electrode plate.

The above information disclosed in this Background section is for enhancement of understanding of the background of the present disclosure, and therefore, it may contain information that does not constitute related (or prior) art.

### SUMMARY

According to an embodiment, there is provided a secondary battery electrode including a current collector; a plurality of mixture parts in which a slurry is coated on the current collector; and a plurality of uncoated parts in which the slurry is uncoated on the current collector, wherein the plurality of uncoated parts include an edge uncoated part positioned in either edge of the current collector and a gap uncoated part positioned between the plurality of mixture parts, the plurality of mixture parts are positioned to be spaced apart parallel with each other with the gap uncoated part interposed therebetween, and a width of the edge uncoated part and a width of the gap uncoated part are smaller than a width of each of the plurality of mixture parts.

According to an embodiment, the plurality of mixture parts may include a first mixture part and a second mixture part, and a width of the first mixture part corresponds to a width of the second mixture part.

According to an embodiment, the edge uncoated part may include a first edge uncoated part and a second edge uncoated part, and a width of the first edge uncoated part corresponds to a width of the second edge uncoated part.

According to an embodiment, a ratio of the width of the gap uncoated part to the width of the first mixture part may be 3 % to 4 %.

According to an embodiment, a ratio of the width of the edge uncoated part to the width of the first mixture part may be 3 % to 4 %.

According to an embodiment, the plurality of mixture parts may include a first mixture part, a second mixture part, and a third mixture part, and widths of the first to third mixture parts may correspond to each other.

According to an embodiment, the edge uncoated part may include a first edge uncoated part and a second edge uncoated part, and a width of the first edge uncoated part may correspond to a width of the second edge uncoated part.

According to an embodiment, the gap uncoated part may include gap uncoated part and a second gap uncoated part, a width of the first gap uncoated part may correspond to a width of the second gap uncoated part, and a ratio of the width of the gap uncoated part to the width of the first mixture part may be 3 % to 4 %.

According to an embodiment, a ratio of the width of the edge uncoated part to the width of the first mixture part may be 3 % to 4 %.

According to an embodiment, the slurry may include an active material, a binder, and a conductive agent.

According to an embodiment, the current collector may include copper.

According to an embodiment, the active material may include graphite or carbon.

According to an embodiment, the current collector may include aluminum.

According to an embodiment, the active material may include transition metal oxide.

According to an embodiment, there is provided an apparatus for manufacturing a secondary battery electrode including: a storage unit configured to store a slurry; a slot die coupled to the storage unit and configured to discharge the slurry onto the current collector; and a slurry pump coupled to the storage unit and the slot die and configured to supply the slurry to the slot die from the storage unit, wherein the slot die discharges the slurry onto the current collector so that the electrode includes a plurality of mixture parts in which the slurry is coated on the current collector and a plurality of uncoated parts in which the slurry is uncoated on the current collector, the plurality of uncoated parts include an edge uncoated part positioned in either edge of the current collector and a gap uncoated part positioned between the plurality of mixture parts, the plurality of mixture parts are positioned to be spaced apart parallel with each other with the gap uncoated part interposed therebetween, and a width of the edge uncoated part and a width of the gap uncoated part are smaller than a width of each of the plurality of mixture parts.

According to an embodiment, an apparatus for manufacturing a secondary battery electrode may further include a dry device configured to dry the slurry discharged onto the current collector.

According to an embodiment, the plurality of mixture parts may include a first mixture part and a second mixture part, and a width of the first mixture part may correspond to a width of the second mixture part.

According to an embodiment, the edge uncoated part may include a first edge uncoated part and a second edge uncoated part, and a width of the first edge uncoated part may correspond to a width of the second edge uncoated part.

According to an embodiment, a ratio of the width of the gap uncoated part to the width of the first mixture part may be 3 % to 4 %.

According to an embodiment, a ratio of the width of the edge uncoated part to the width of the first mixture part may be 3 % to 4 %.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a plan view of an electrode of a secondary battery according to some embodiments of the present disclosure.

FIG. 2 is an image of a secondary battery electrode according to comparative examples of the present disclosure.

FIG. 3 is an image of a secondary battery electrode according to comparative examples of the present disclosure.

FIG. 4 is a plan view of a slit secondary battery electrode according to some embodiments of the present disclosure.

FIG. 5 is a plan view of a secondary battery electrode according to some embodiments of the present disclosure.

FIG. 6 is a plan view of a slit secondary battery electrode according to some embodiments of the present disclosure.

FIG. 7 is a configuration diagram of an apparatus for manufacturing a secondary battery electrode according to some embodiments of the present disclosure.

FIG. 8 is a schematic diagram of a coating device according to some embodiments of the present disclosure.

FIG. 9 is a diagram of a current collector coated by the coating device of FIG. 8 according to a process of manufacturing an electrode plate.

FIG. 10 is a configuration diagram of a dry device according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, dimensions and relative dimensions of layers and regions illustrated in drawings may be exaggerated for clarity of explanation. That is, the dimensions illustrated in drawings are only for convenience of understanding and are not limited thereto. Further, the same reference numerals throughout the specification designate the same elements.

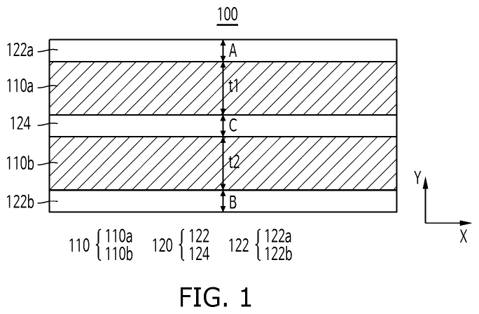

FIG. 1 is a plan view illustrating an example of an electrode of a secondary battery according to some embodiments of the present disclosure.

Referring to FIG. 1, according to some embodiments, a secondary battery electrode 100 may include a current collector, a plurality of mixture parts 110 in which a slurry is coated on the current collector, and a plurality of uncoated parts 120 in which the slurry is not coated on the current collector. The slurry applied onto the current collector may include an active material, a binder, and a conductive agent, and a polarity of the electrode may be set according to the type of slurry. The secondary battery electrode 100 illustrated in FIG. 1 may be an electrode for a lithium secondary battery.

According to some embodiments, the current collector may serve as a positive electrode. For example, the current collector may be configured of aluminum (Al), and the active material may include a transition metal oxide. In other embodiments, the current collector may serve as a negative electrode. For example, the current collector may be configured of a copper (Cu) foil, and the active material may include a carbon material, e.g., graphite.

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material). For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1−bXbO2−cDc (0.90≤a≤1.8, 0≤b≤0.5, and 0≤c≤0.05); LiaMn2−bXbO4−cDc (0.90≤a≤1.8, 0≤b≤0.5, and 0≤c≤0.05); LiaNi1−b−cCobXcO2−αDα (0.90≤a≤1.8, 0≤b≤0.5, 0≤c≤0.5, and 0<α<2); LiaNi1−b−cMnbXcO2−αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1−bGbO2 (0.90≤a≤1.8 and 0.001≤b≤0.1); LiaMn2GbO4 (0.90≤a≤1.8 and 0.001≤b≤0.1); LiaMn1−gGgPO4 (0.90≤a≤1.8 and 0≤g≤0.5); Li(3−f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

Al may be used as the current collector, but is not limited thereto.

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The negative current collector may include a copper foil, a nickel foil, a stainless steel foil, a titanium foil, a nickel foam, a copper foam, a polymer substrate coated with a conductive metal, or a combination thereof.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Each of the positive electrode and the negative electrode may be manufactured by applying and drying the slurry including the active material onto a substrate in the electrode process out of the secondary battery manufacturing processes. While passing through the dry unit, the solvent constituting a portion of the slurry may be evaporated and thus the slurry applied onto the substrate may be dried.

The dry process of the secondary battery electrode may be a process for improving the performance and safety of the battery and may be performed while controlling an amount of dry heat. All the performance, safety, and manufacturing efficiency of the secondary battery may be improved by increasing the amount of dry heat. However, when the amount of dry heat is equal to or larger than a reference value, material damage or thermal deformation may be caused. Accordingly, widths of the plurality of mixture parts and widths of the plurality of uncoated parts on the current collector may be set (e.g., adjusted) in consideration of the amount of dry heat.

As illustrated in FIG. 1, according to some embodiments, the plurality of uncoated parts 120 may include edge uncoated parts 122 positioned along both edges (e.g., opposite edges) of the current collector and a gap uncoated part 124 positioned between the plurality of mixture parts 110. For example, referring to FIG. 1, the gap uncoated part 124 may extend lengthwise in the X-axis direction along the center of the current collector and between the edge uncoated parts 122 I the Y-axis direction.

The plurality of mixture parts 110 may be positioned to be spaced apart from each other (e.g., in the Y-axis direction) and parallel with each other, with the gap uncoated part 124 interposed therebetween. Widths A and B of the edge uncoated parts 122 and a width C of the gap uncoated part 124 may be smaller than widths t1 and t2 of the plurality of mixture parts 110. The widths A and B of the edge uncoated parts 122 and the width C of the gap uncoated part 124 may refer to widths of the edge uncoated parts 122 and the gap uncoated part 124 in the Y-axis direction, respectively.

According to some embodiments, the plurality of mixture parts 110 may include a first mixture part 110a and a second mixture part 110b, and the width t1 of the first mixture part 110a and the width t2 of the second mixture part 110b may correspond to (e.g., equal) each other. For example, the width t1 of the first mixture part 110a may be the same as the width t2 of the second mixture part 110b.

According to some embodiments, the edge uncoated parts 122 may include a first edge uncoated part 122a and a second edge uncoated part 122b, and the width A of the first edge uncoated part 122a and the width B of the second edge uncoated part 122b may correspond to each other. For example, the width A of the first edge uncoated part 122a may be the same as the width B of the second edge uncoated part 122b.

According to some embodiments, a ratio of the width C of the gap uncoated part 124 to the width t1 of the first mixture part 110a may be 3 % to 4 %. The width t1 of the first mixture part 110a and the width t2 of the second mixture part 110b may correspond to each other, and thus a ratio of the width C of the gap uncoated part 124 to the width t2 of the second mixture part 110b may be 3 % to 4 %. The ratio of the width C of the gap uncoated part 124 to the width t1 of the first mixture part 110a may be 0.03:1 to 0.04:1. Considering the amount of dry heat, the ratio of the width C of the gap uncoated part 124 to the width t1 of the first mixture part 110a may be set to 0.035:1.

According to some embodiments, ratios of the widths A and B of the edge uncoated parts 122 to the width t1 of the first mixture part 110a may be 3 % to 4 %. The width t1 of the first mixture part 110a and the width t2 of the second mixture part 110b may correspond to each other, and thus ratios of the widths A and B of the edge uncoated parts 122 to the width t2 of the second mixture part 110b may be 3 % to 4 %. The ratios of the widths A and B of the edge uncoated parts 122 to the width t1 of the first mixture part 110a may be 0.03:1 to 0.04:1. Considering the amount of dry heat, the ratios of the widths A and B of the edge uncoated parts 122 to the width t1 of the first mixture part 110a may be set to 0.035:1.

As described above, in drying of the secondary battery electrode 100 according to some embodiments of the present disclosure, wrinkles may be prevented from being formed in the edge uncoated parts 122 and the gap uncoated part 124. By such a characteristic structure, even when the amount of dry heat is increased, the wrinkles may be prevented from being formed in the uncoated parts, thereby improving overall processing and efficiency during subsequent processing stages, e.g., slitting.

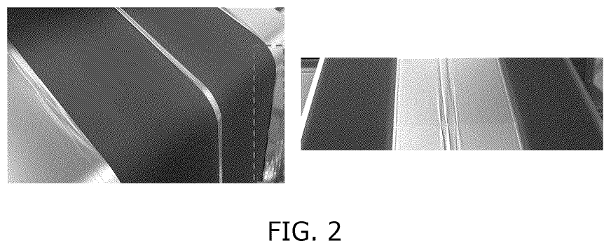

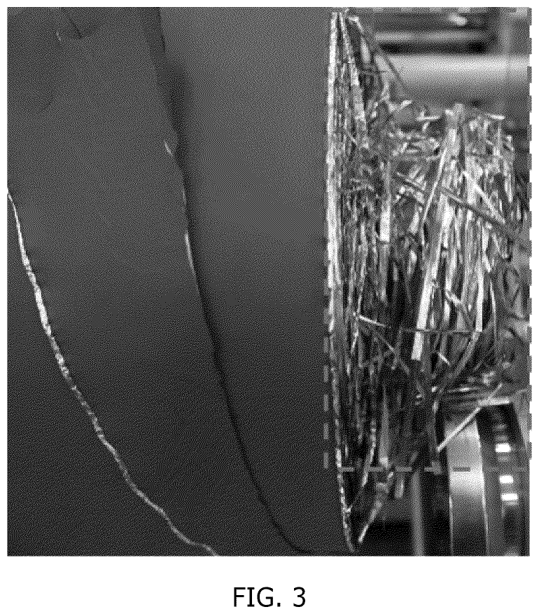

FIG. 2 is a diagram illustrating an example of a secondary battery electrode according to comparative examples of the present disclosure, and FIG. 3 is a diagram illustrating an example of a secondary battery electrode according to comparative examples of the present disclosure.

In FIG. 2, the secondary battery electrode includes a mixture part having a dark color due to coating of a slurry on a current collector and an uncoated part having a lighter color (i.e., the color of the current collector due to non-coating of the slurry on the current collector). The current collector of the electrode may include copper, and thus the uncoated part in which the slurry is uncoated on the current collector may have a copper color.

The secondary battery electrode may include a plurality of mixture parts in which the slurry is coated on the current collector and a plurality of uncoated parts in which the slurry is not coated on the current collector. The plurality of uncoated parts may include edge uncoated parts disposed in both edges of the current collector and a gap uncoated part positioned between the plurality of mixture parts. The plurality of mixture parts may be positioned to be spaced apart and parallel with each other, with the gap uncoated part interposed therebetween. Widths of the plurality of mixture parts may correspond to each other.

Referring to the left image of FIG. 2, widths of the edge uncoated parts (light color) of the secondary battery electrode are larger than the widths of the mixture parts (dark color). The edge uncoated parts positioned in both edges of the current collector correspond to each other. Accordingly, the width of each uncoated part may be larger than the width of each mixture part. A ratio of the width of the edge uncoated part to the width of the mixture part may be 1.11:1. Thus, when the amount of dry heat is increased, wrinkles may be formed in the edge uncoated part, and the edge uncoated part may be folded.

Referring to the right image of FIG. 2, the width of the gap uncoated part of the secondary battery electrode is larger than the widths of the mixture parts. The width of the gap uncoated part may be larger than the width of each mixture part. The ratio of the width of the gap uncoated part to the width of the mixture part may be 1.46:1. Thus, when the amount of dry heat is increased, wrinkles may be formed in the gap uncoated part, and the gap uncoated part may be folded. As shown in FIG. 3, problems may occur due to the wrinkles of the uncoated part in slitting of the secondary battery electrode.

To increase the amount of dry heat, it may be desirable to reduce the widths of the edge uncoated part and the gap uncoated part.

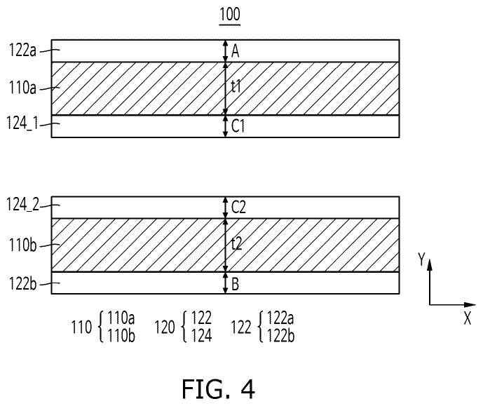

FIG. 4 is a plan view illustrating an example of a slit secondary battery electrode according to some embodiments of the present disclosure. Description for the plurality of uncoated parts and the plurality of mixture parts is the same as described above, with reference to FIG. 1, and will not be repeated.

Referring to FIG. 4, the secondary battery electrode 100 may be slit in the gap uncoated part 124 region. After slitting, the gap uncoated part 124 may be divided into an uncoated part 124_1 coupled to the first mixture part 110a and an uncoated part 124_2 coupled to the second mixture part 110b. A width C1 of the uncoated part 124_1 coupled to the first mixture part 110a may correspond to (e.g., equal) a width C2 of the uncoated part 124_2 coupled to the second mixture part 110b.

The width C of the gap uncoated part 124 may be set in consideration of slitting. Accordingly, damages which may occur in the plurality of mixture parts 110 and the plurality of uncoated parts 120 during slitting may be prevented or substantially minimized.

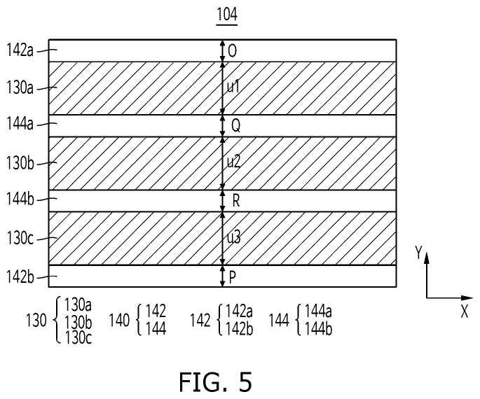

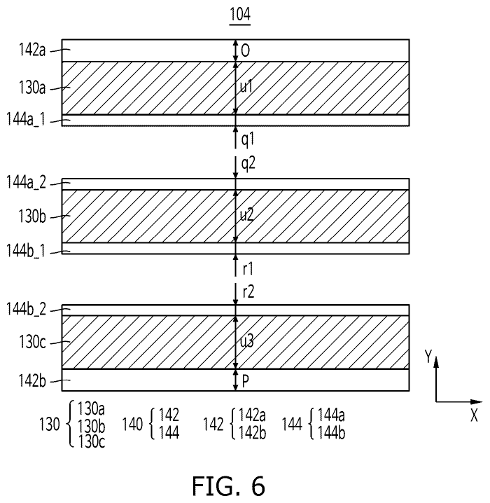

FIG. 5 is a plan view illustrating an example of a secondary battery electrode according to some embodiments of the present disclosure. FIG. 6 is a plan view illustrating an example of a slit secondary battery electrode according to some embodiments of the present disclosure.

Referring to FIG. 5, according to some embodiments, in a secondary battery electrode 104, a plurality of mixture parts 130 may include a first mixture part 130a, a second mixture part 130b, and a third mixture part 130c, and widths u1, u2, and u3 of the first to third mixture parts 130a, 130b, and 130c may correspond to each other. For example, the widths u1, u2, and u3 of the first to third mixture parts 130a, 130b, and 130c may be the same as each other.

According to some embodiments, an edge uncoated part 142 may include a first edge uncoated part 142a and a second edge uncoated part 142b, and a width O of the first edge uncoated part 142a may correspond to a width P of the second edge uncoated part 142b. For example, the width O of the first edge uncoated part 142a may be the same as the width P of the second edge uncoated part 142b.

According to some embodiments, a gap uncoated part 144 may include a first gap uncoated part 144a and a second gap uncoated part 144b. A width Q of the first gap uncoated part 144a may correspond to a width R of the second gap uncoated part 144b, and ratios of the widths Q and R of the gap uncoated parts 144 to the width u1 of the first mixture part 130a may be 3 % to 4 %.

According to some embodiments, the widths u1, u2, and u3 of the first to third mixture parts 130a, 130b, and 130c may correspond to each other, and thus ratios of the widths Q and R of the gap uncoated parts 144 to the width u2 of the second mixture part 130b may be 3 % to 4 %. Further, ratios of the widths Q and R of the gap uncoated parts 144 to the width u3 of the third mixture part 130c may be 3 % to 4 %. For example, the ratios of the widths Q and R of the gap uncoated parts 144 to the width u1 of the first mixture part 130a may be 0.03:1 to 0.04:1. Considering the amount of dry heat, the ratios of the widths Q and R of the gap uncoated parts 144 to the width u1 of the first mixture part 130a may be set to 0.035:1.

According to some embodiments, ratios of the widths O and P of the edge uncoated parts 142 to the width u1 of the first mixture part 130a may be 3 % to 4 %. The widths u1, u2, and u3 of the first to third mixture parts 130a, 130b, and 130c may correspond to each other, and thus ratios of the widths O and P of the edge uncoated parts 142 to the width u2 of the second mixture part 130b may be 3 % to 4 %. Further, ratios of the widths O and P of the edge uncoated parts 142 to the width u3 of the third mixture part 130c may be 3 % to 4 %. For example, the ratios of the widths O and P of the edge uncoated parts 142 to the width u1 of the first mixture part 130a may be 0.03:1 to 0.04:1. Considering the amount of dry heat, the ratios of the widths O and P of the edge uncoated parts 142 to the width u1 of the first mixture part 130a may be set to 0.035:1.

Referring to FIG. 6, the secondary battery electrode 104 may be slit in both gap uncoated parts 144 regions. After slitting, the gap uncoated part 144a may be divided into an uncoated part 144a_1 coupled to the first mixture part 130a and an uncoated part 144a_2 coupled to the second mixture part 130b. A width q1 of the uncoated part 144a_1 coupled to the first mixture part 130a may correspond to a width q2 of the uncoated part 144a_2 coupled to the second mixture part 130b. Similarly, the gap uncoated part 144b may be divided into an uncoated part 144b_1 coupled to the second mixture part 130b and an uncoated part 144b_2 coupled to the third mixture part 130c. A width r1 of the uncoated part 144b_1 coupled to the second mixture part 130b may correspond to a width r2 of the uncoated part 144b_2 coupled to the third mixture part 130c.

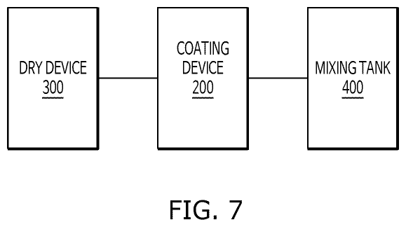

FIG. 7 is a configuration diagram illustrating an example of an apparatus for manufacturing a secondary battery electrode according to some embodiments of the present disclosure.

Referring to FIG. 7, the apparatus for manufacturing a secondary battery electrode according to some embodiments of the present disclosure may include a coating device 200 (e.g., a coater), a dry device 300 (e.g., a dryer), and a mixing tank 400 (e.g., a mixer).

The slurry for manufacturing the secondary battery electrode may be manufactured and stored within the mixing tank 400. The slurry may be manufactured by mixing a solvent, an active material, a conductive agent, and a binder. For example, the slurry may include a slurry for a positive electrode active material or a slurry for a negative electrode active material. The slurry stored in the mixing tank 400 may be supplied to the coating device 200 through a connection pipe.

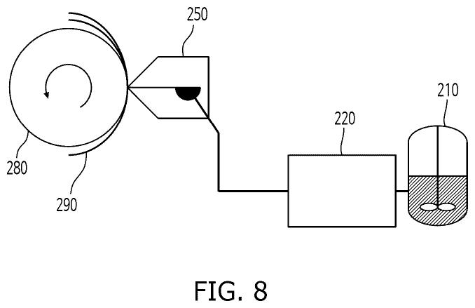

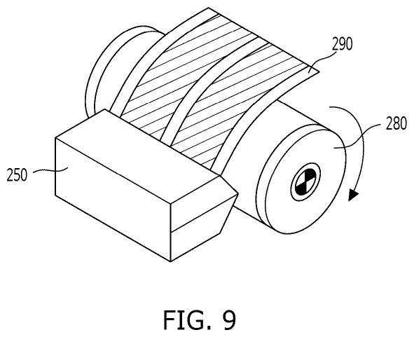

The coating device 200 may perform a coating process which applies the slurry received from the mixing tank 400 onto the substrate. A slurry measuring unit of the coating device 200 may measure a flow rate and density of the slurry. A controller of the coating device 200 may control a supply unit of the coating device 200 based on the measured flow rate and density of the slurry. A configuration of the coating device 200 will be described in detail with reference to FIGS. 8 and 9.

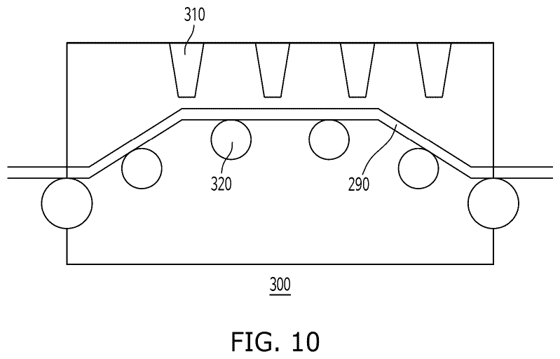

The dry device 300 may dry the slurry applied onto a surface of the substrate to form a mixture layer. The dry device 300 may include any suitable dry device used in the coating device 200. For example, the dry device 300 may be disposed in a rear of a slot die on the basis of a traveling direction of the substrate, so that an electrode plate onto which the slurry is applied may be introduced into the dry device 300. While the electrode plate passes through the dry device 300, a solvent of the slurry may be volatilized (e.g., evaporated) by hot air discharged from the dry device 300. The dry device 300 may be formed to have a length sufficient to completely dry the slurry. For example, the dry device 300 may be used in a wet process. For example, when the electrode is manufactured using a dry process, the dry device 300 may be omitted, and the secondary battery electrode may be manufactured using the coating device 200 and the mixing tank 400. A configuration of the dry device 300 will be described in detail with reference to FIG. 10.

FIG. 8 is a configuration diagram illustrating an example of the coating device according to some embodiments of the present disclosure, and FIG. 9 is a diagram illustrating an example in which a current collector is coated by the coating device of FIG. 8 according to a process of manufacturing an electrode plate.

Referring to FIGS. 8 and 9, the coating device 200 may include a storage unit 210 (e.g., a storage), a slurry pump 220, a slurry measuring unit, a pipe, a slot die 250, a backup roll 280, and a controller.

In the present disclosure, the term “coupled” means that a component is directly coupled to another component or is coupled to another component through a separate connection pipe. For example, the sentence “the storage unit 210 and the slurry pump 220 are coupled” means that ports of the storage unit 210 and the slurry pump 220 may be directly coupled, may be coupled through a connection pipe, or may be coupled via the connection pipe and an additional component (e.g., flow rate control valve, pump, and the like).

Referring to FIG. 8, the storage unit 210 may store the slurry. For example, the storage unit 210 may receive and store the slurry manufactured in the mixing tank 400. The storage unit 210 may include a receiving space (e.g., slurry storage tank). An outlet port of the storage unit 210 may be coupled to the slurry pump 220. In some embodiments, the storage unit 210 may further include a mixer within the receiving space. The mixer may mix the slurry to constantly maintain viscosity of the slurry within the receiving space.

The slurry supplied from the storage unit 210 may be supplied to the slot die 250 via the slurry pump 220. The controller may control the slurry pump 220 to supply the slurry supplied from the storage unit 210 to the slot die 250 or to reflux the slurry to the storage unit 210.

An inlet port of the slurry pump 220 may be coupled to the outlet port of the storage unit 210. The slurry pump 220 may supply the slurry stored in the storage unit 210 to the slot die 250. The slurry pump 220 may include a pump and a pulsation damper which reduces pulsation of the pump. For example, the pump may include any one of a diaphragm pump, a gear pump, a plunger pump, and a peristaltic pump. The pulsation damper may include an air chamber or accumulator.

An inlet port of the slot die 250 may be coupled to the slurry pump 220. The slot die 250 may be disposed to be spaced apart from a surface of a current collector 290. The slot die 250 may include a spray port formed in a slit shape. The slurry may be discharged through the spray port of the slot die 250 and applied onto the current collector 290. For example, while the backup roll 280 rotates, the current collector 290 may be provided onto the slot die 250 and the slurry may be applied onto the surface of the current collector 290.

The slot die 250 may include a gap adjustment module. The gap adjustment module may adjust a gap between an upper part and a lower part of the spray port to control an amount of the slurry to be discharged.

According to some embodiments, the slot die 250 may discharge the slurry onto the current collector 290 so that the electrode includes the plurality of mixture parts in which the slurry is coated on the current collector and the plurality of uncoated parts in which the slurry is not coated on the current collector, as discussed previously with reference to FIGS. 1 and 4. The plurality of uncoated parts may include the edge uncoated parts positioned in both edges of the current collector and the gap uncoated part positioned between the plurality of mixture parts. The plurality of mixture parts may be positioned to be spaced apart parallel with each other with the gap uncoated part interposed therebeween, and the widths of the edge uncoated parts and the width of the gap uncoated part may be smaller than the widths of the plurality of mixture parts.

According to some embodiments, the plurality of mixture parts may include the first mixture part and the second mixture part, and the width of the first mixture part may correspond to the width of the second mixture part.

According to some embodiments, the edge uncoated parts may include the first edge uncoated part and the second edge uncoated part, and the width of the first edge uncoated part may correspond to the width of the second edge uncoated part.

According to some embodiments, the ratio of the width of the gap uncoated part to the width of the first mixture part may be 3 % to 4 %. The width of the first mixture part may correspond to the width of the second mixture part, and thus the ratio of the width of the gap uncoated part to the width of the second mixture part may be 3 % to 4 %. The ratio of the width of the gap uncoated part to the width of the first mixture part may be 0.03: to 0.04:1. Considering the amount of dry heat, the ratio of the width of the gap uncoated part to the width of the first mixture part may be set to 0.035:1.

According to some embodiments, the ratios of the widths of the edge uncoated parts to the width of the first mixture part may be 3 % to 4 %. The width of the first mixture part may correspond to the width of the second mixture part, and thus the ratios of the widths of the edge uncoated parts to the width of the second mixture part may be 3 % to 4 %. The ratios of the widths of the edge uncoated parts to the width of the first mixture part may be 0.03: to 0.04:1. Considering the amount of dry heat, the ratios of the widths of the edge uncoated parts to the width of the first mixture part may be set to 0.035:1.

As described above, during drying of the secondary battery electrode according to some embodiments of the present disclosure, wrinkles may be prevented from being formed in the edge uncoated parts and the gap uncoated part. By such a characteristic structure, even when the amount of dry heat is increased, wrinkles may be prevented from being formed in the uncoated parts, and thus potential problems occurring during slitting may be prevented.

FIG. 10 is a configuration diagram illustrating an example of a dry device according to some embodiments of the present disclosure.

Referring to FIG. 10, the dry device 300 may include a nozzle 310, a supply pipe, and a roller 320. However, the dry device 300 may further include another configuration or a portion of configurations may be omitted from the dry device 300.

The supply pipe may supply gas to the nozzle 310. A certain number of supply pipes may be coupled to each nozzle.

The supply pipe may be coupled to a gas generation device (e.g., a hot air generation device) for drying the slurry for the electrode, and an amount of gas transferred to the supply pipe using a pump, a fan, a valve, and the like and/or an amount of gas supplied to the nozzle 310 may be controlled.

The current collector 290 may be introduced into the inside of the dry device 300 or withdrawn from the dry device 300 toward the outside while moving using the roller 320. The roller 320 may rotate at a constant speed to introduce the current collector 290 into the inside of the dry unit and to withdraw the current collector 290 from the dry unit toward the outside, continuously.

By way of summation and review, in an electrode process during a secondary battery manufacturing process, each of the positive electrode and the negative electrode in the secondary battery may be manufactured by applying and drying the slurry including the active material onto a substrate. In general, while the slurry applied onto the substrate passes through a dry unit, a solvent constituting a portion of the slurry may be evaporated and thus the slurry may be dried. However, during drying of the slurry, wrinkles may be formed in the uncoated portion according to an amount of dry heat, e.g., thereby potentially causing problems in a subsequent process such as slitting.

In contrast, aspects of embodiments of the present disclosure provide an electrode of a secondary battery which prevents wrinkles from being formed due to a large amount of dry heat when a slurry is applied and then dried onto a current collector, and an apparatus for manufacturing the electrode of a secondary battery.

According to some embodiments of the present disclosure, an electrode of a secondary battery, which prevents wrinkles from being formed due to a large amount of dry heat when a slurry is applied and then dried onto a current collector, may be provided.

According to some embodiments of the present disclosure, when the slurry is applied and then dried onto the current collector, wrinkles may be prevented from being formed in an uncoated portion even in a large amount of dry heat, and thus all the performance, safety, and manufacturing efficiency of the secondary battery may be improved by increasing the amount of dry heat.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery electrode, comprising:
a current collector;
mixture parts on the current collector, the mixture parts including a slurry, and the mixture parts being spaced apart and parallel with each other; and
uncoated parts on the current collector, the uncoated parts including no slurry, the uncoated parts including an edge uncoated part on an edge of the current collector and a gap uncoated part between the mixture parts, and a width of the edge uncoated part and a width of the gap uncoated part being smaller than a width of each of the mixture parts.

2. The secondary battery electrode as claimed in claim 1, wherein the mixture parts include a first mixture part and a second mixture part, a width of the first mixture part corresponding to a width of the second mixture part.

3. The secondary battery electrode as claimed in claim 2, wherein the edge uncoated part includes a first edge uncoated part and a second edge uncoated part, a width of the first edge uncoated part corresponding to a width of the second edge uncoated part.

4. The secondary battery electrode as claimed in claim 3, wherein a ratio of the width of the gap uncoated part to the width of the first mixture part is 3 % to 4 %.

5. The secondary battery electrode as claimed in claim 4, wherein a ratio of the width of the edge uncoated part to the width of the first mixture part is 3 % to 4 %.

6. The secondary battery electrode as claimed in claim 1, wherein the mixture parts include a first mixture part, a second mixture part, and a third mixture part, widths of the first to third mixture parts corresponding to each other.

7. The secondary battery electrode as claimed in claim 6, wherein the edge uncoated part includes a first edge uncoated part and a second edge uncoated part, a width of the first edge uncoated part corresponding to a width of the second edge uncoated part.

8. The secondary battery electrode as claimed in claim 7, wherein:
the gap uncoated part includes a first gap uncoated part and a second gap uncoated part,
a width of the first gap uncoated part corresponds to a width of the second gap uncoated part, and
a ratio of the width of the first gap uncoated part to the width of the first mixture part is 3 % to 4 %.

9. The secondary battery electrode as claimed in claim 8, wherein a ratio of the width of the edge uncoated part to the width of the second mixture part is 3 % to 4 %.

10. The secondary battery electrode as claimed in claim 1, wherein the slurry includes an active material, a binder, and a conductive agent.

11. The secondary battery electrode as claimed in claim 10, wherein the current collector includes copper.

12. The secondary battery electrode as claimed in claim 11, wherein the active material includes graphite or carbon.

13. The secondary battery electrode as claimed in claim 10, wherein the current collector includes aluminum.

14. The secondary battery electrode as claimed in claim 13, wherein the active material includes transition metal oxide.

15. An apparatus for manufacturing a secondary battery electrode, the apparatus comprising:
a storage configured to store a slurry;
a slot die coupled to the storage, the slot die being configured to discharge the slurry onto a current collector; and
a slurry pump coupled to the storage and the slot die, the slurry pump being configured to supply the slurry to the slot die from the storage,
wherein:
the slot die is configured to discharge the slurry onto the current collector so that the secondary battery electrode includes mixture parts in which the slurry is coated on the current collector and uncoated parts without slurry on the current collector,
the uncoated parts include an edge uncoated part at an edge of the current collector and a gap uncoated part between the mixture parts,
the mixture parts are spaced apart parallel with each other, the gap uncoated part being between the mixture parts, and
a width of the edge uncoated part and a width of the gap uncoated part are smaller than a width of each of the mixture parts.

16. The apparatus as claimed in claim 15, further comprising a dry device configured to dry the slurry discharged onto the current collector.

17. The apparatus as claimed in claim 16, wherein the mixture parts include a first mixture part and a second mixture part, a width of the first mixture part corresponding to a width of the second mixture part.

18. The apparatus as claimed in claim 17, wherein the edge uncoated part includes a first edge uncoated part and a second edge uncoated part, a width of the first edge uncoated part corresponding to a width of the second edge uncoated part.

19. The apparatus as claimed in claim 18, wherein a ratio of the width of the gap uncoated part to the width of the first mixture part is 3 % to 4 %.

20. The apparatus as claimed in claim 19, wherein a ratio of the width of the edge uncoated part to the width of the first mixture part is 3 % to 4 %.
